(19) United States
(12) Patent Application Publication
(10) Pub. No.: US 2011/0244303 A1
(43) Pub. Date: Oct. 6, 2011

(54) Metalized Ceramic and Associated Method

(75) Inventors: Mohamed Rahmane, Ballston Lake, NY (US); Darren Michael Stohr, Schenectady, NY (US); James Anthony Brewer, Scotia, NY (US); Dong-Sil Park, Niskayuna, NY (US)

(73) Assignee: GENERAL ELECTRIC COMPANY, Schenectady, NY (US)

(21) Appl. No.: 12/753,425

(22) Filed: Apr. 2, 2010

(51) Int. Cl. H01M 2/00; B32B 15/04; B32B 5/00; B05D 5/12

(52) U.S. Cl. 429/122; 428/450; 428/469; 428/337; 428/334; 427/123

(57) ABSTRACT

A metalized ceramic comprising a ceramic substrate comprising a first ceramic and a ceramic metallization layer disposed on the ceramic substrate. The ceramic metallization layer comprises a mixture of (i) a second ceramic and (ii) a metal comprising nickel or a refractory metal. The refractory metal may consist one or more of molybdenum, tungsten, niobium and tantalum. The first ceramic and the second ceramic have a purity of greater than about 95 percent. A method of making the metalized ceramic is provided. An electrochemical cell including the metalized ceramic is also provided.

### STATEMENT REGARDING FEDERALLY SPONSORED RESEARCH

The disclosure was made in part with U.S. Government support under Contract # MA-04-7001 awarded by Federal Transportation Agency. The U.S. Government has certain rights to this invention.

### BACKGROUND

1. Technical Field

The invention includes embodiments that relate to a metalized ceramic. The invention includes embodiments that relate to a metalized ceramic to be used in the seal structure of an energy storage device. The invention includes embodiments that relate to a method of forming the metalized ceramic. The invention also includes embodiments that relate to an electrochemical cell including the metalized ceramic.

2. Discussion of Related Art

Development work has been undertaken on high temperature rechargeable batteries using sodium for the negative electrode. The liquid sodium negative electrode is separated from a positive electrode by a sodium-ion conducting solid electrolyte. Suitable material includes beta-alumina and beta″-alumina, known together as beta-alumina solid electrolyte (BASE), which is used as the separator of electrodes. Some electrochemical cells have a metallic casing. The ceramic parts of the cell can be joined or bonded via a sealing material. The ceramic parts and metal parts of the cell can be joined by forming a metalized ceramic, wherein the metalized portion of the ceramic bonds to the metal via a ceramic-to-metal physical bond. Current methods include the formation of a metalized ceramic comprising a ceramic substrate and a ceramic metallization layer having an interface comprising a ceramic-to-metal physical bond. The metal parts can be disposed over the ceramic metallization layer to form the ceramic-metal diffusion thermal compression bond. The life of the electrochemical cell is dependent on the integrity and strength of the joints and the bonds.

It may be desirable to have a metalized ceramic that differs from those metalized ceramics that are currently available. It may be desirable to have a method of forming a metalized ceramic that differs from those methods that are currently available. It may be desirable to have an energy storage device, for example, an electrochemical cell that uses the metalized ceramic.

### BRIEF DESCRIPTION

In accordance with an embodiment of the invention, a metalized ceramic is provided. The metalized ceramic comprises a ceramic substrate comprising a first ceramic and a ceramic metallization layer disposed on the ceramic substrate. The ceramic metallization layer comprises a mixture of (i) a second ceramic and (ii) a metal comprising nickel or a refractory metal. The refractory metal may consist one or more of molybdenum, tungsten, niobium and tantalum. The first ceramic and the second ceramic have a purity of greater than about 95 percent.

In accordance with another embodiment of the invention a method, is provided. The method comprises disposing a layer of an ink composition on a ceramic substrate to form a coated ceramic substrate. The ceramic substrate comprises a first ceramic. The ink composition comprises a mixture of a second ceramic, a metal comprising nickel or a refractory metal and an organic vehicle material. The refractory metal consists of one or more of molybdenum, tungsten, niobium and tantalum. The first ceramic and the second ceramic have a purity of greater than about 95 percent. The method further comprises a step of sintering the coated ceramic substrate in a reducing atmosphere to form a physical bond between the layer of the ink composition and the ceramic substrate to form a ceramic metallization layer on the surface of the ceramic substrate.

In accordance with yet another embodiment of the invention a method is provided. The method comprises disposing a layer of an ink composition on a ceramic substrate to form a coated ceramic substrate. The ceramic substrate comprises a first ceramic. The ink composition comprises a mixture of a second ceramic, a metal, and an organic vehicle material. The metal comprises nickel or a refractory metal consisting of one or more of molybdenum, tungsten niobium, and tantalum. The first ceramic and the second ceramic have a purity of greater than about 95 percent. The method further comprises sintering the coated ceramic substrate in a reducing atmosphere to form a physical bond between the layer and the ceramic substrate to form a ceramic metallization layer. The method further comprises disposing a metal layer on the ceramic metallization layer; and sintering the metal-coated ceramic metallization layer to form a diffusion bond between the metal layer and the metalized ceramic.

In accordance with yet another embodiment of the invention an electrochemical cell is provided. The cell comprises an anode current collector attached to a anode terminal, a cathode current collector attached to a cathode terminal, a ion-conducting first electrolyte, and an electrically insulating collar disposed on the ion-conducting first electrolyte. The electrically insulating collar comprises a ceramic substrate comprising a first ceramic. A ceramic metallization layer is disposed on the ceramic substrate. The ceramic metallization layer comprises a mixture of (i) a second ceramic and (ii) a metal comprising nickel or a refractory metal. The refractory metal consists of one or more of molybdenum, tungsten, niobium, and tantalum. The first ceramic and the second ceramic have a purity of greater than about 95 percent.

### BRIEF DESCRIPTION OF DRAWINGS

FIG. 1 is a schematic view showing an electrochemical cell.

FIG. 2 is a schematic view showing a metalized ceramic in accordance with one embodiment of the invention.

FIG. 3 is a schematic view showing a step-wise method of forming a metalized ceramic in accordance with one embodiment of the invention.

FIG. 4 is a schematic view showing a step-wise method of forming a metalized ceramic-metal bond in accordance with one embodiment of the invention.

FIG. 5 is a schematic view showing an electrochemical cell using a metalized ceramic in accordance with one embodiment of the invention.

FIG. 6 is a scanning electron micrograph of a metalized ceramic in accordance with one embodiment of the invention.

FIG. 7 is a scanning electron micrograph of a metalized ceramic in accordance with one embodiment of the invention.

FIG. 8 is a scanning electron micrograph of a metalized ceramic in accordance with one embodiment of the invention.

### DETAILED DESCRIPTION

The invention includes embodiments that relate to a metalized ceramic. The invention includes embodiments that relate to a metalized ceramic to be used in the seal structure of an energy storage device. The invention includes embodiments that relate to a method of forming the metalized ceramic. The invention also includes embodiments that relate to an electrochemical cell including the metalized ceramic.

Embodiments of the invention as described herein address the noted shortcomings of the art. The metalized ceramic described herein fills the needs described above by providing an improved corrosion resistance. These electrochemical cells could potentially offer improved lifetime, reliability and cost, demanded by the recent rapid development of a variety of equipments known in the art. As discussed above, metalized ceramics that are currently used in sealing are subject to corrosion resulting in untimely cell failure. As discussed above, the ceramic-metal bond in the art may be formed by metallizing the ceramic. The formation of metalized ceramic typically consists of metallizing an alumina substrate containing about 6 weight percent content of other oxides, with silica and calcium oxide forming the majority of these additives. An ink composition typically consisting of molybdenum or a mixture of molybdenum and manganese may be applied to the alumina substrate and then the resultant coated substrate is sintered at about 1500 degrees Centigrade. During the sintering step, glass comprising silica and calcium oxide in the ceramic substrate, wicks through the grain boundaries of the ceramic substrate into the metal layer, where it fills the pores between the molybdenum particles while also providing a glass bond to the ceramic substrate by forming the ceramic metallization layer. In a final step, the metal to be bonded to the ceramic may be disposed over the metalized ceramic and the resultant assembly heated to about 950 degrees Centigrade under a uniaxial pressure load. This may create a diffusion bond between the metal to be bonded and the molybdenum in the ceramic metallization layer of the metalized ceramic.

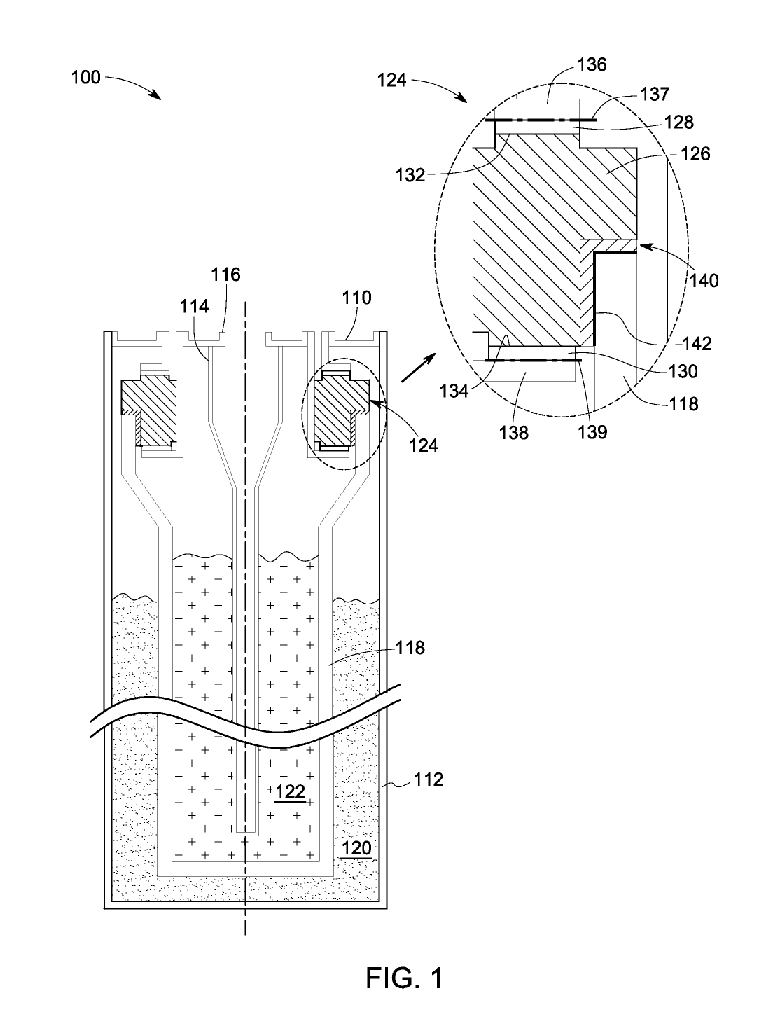

Referring to FIG. 1, a schematic view showing a cross section of an electrochemical cell 100 is provided. FIG. 1 includes an anode current collector 110, attached to an anode terminal 112, a cathode current collector attached 114 attached to a cathode terminal 116, and a beta-alumina tube 118 functioning as the ion-conducting first electrolyte. The electrochemical cell includes an outer metal container that functions as a negative anode terminal 112 for sodium 120 as anodic material. A metal rod functions as the cathode current collector 114, the metal rod being surrounded by a cathodic material 122, a positive electrode material infused with molten halide. A metalized ceramic 124 is formed as discussed above where the ceramic substrate 126 of the metalized ceramic 124 comprises about 6 weight percent of glass i.e., one or more of silica or calcium oxide. Ceramic metallization layers 128, 130 are formed on at least two surfaces 132, 134 of the ceramic substrate 126 to form the metalized ceramic 124 via the formation of a physical bond 137, 139 between the ceramic metallization layers 128, 130 and the ceramic substrate 126. The metal layers 136, 138, for example, nickel layers, are then disposed over the ceramic metallization layers 128, 130. The metal layer 136 is used to connect the metalized ceramic 124 to the negative anode terminal 112, and the metal layer 138 is used to connect the metalized ceramic 124 to the cathode current terminal 114. The metalized ceramic 124 and the metal layers 136, 138 assembly so formed may then be disposed over the beta-alumina tube 118. A sealing glass 140 is employed to bond the metalized ceramic 124 to the beta-alumina tube 118. The portion of the metalized ceramic 124 bonded to the beta-alumina tube 118 may not comprise a ceramic metallization layer, and the bond formed is a ceramic-ceramic bond 142, formed using the sealing glass 140.

The bond strength of the final component i.e., the thermal compression bonded metalized ceramic so formed may depend on the glass content in the ceramic substrate. The glass content in the ceramic substrate may be affected by several parameters that are not easily controllable. The different parameters may include the amount of silica and calcium oxide in the alumina, the ratio of silica to calcium oxide, and the grain size of the alumina substrate. Small variation in the ceramic being used as the ceramic substrate may lead to large variations in bond strength and therefore reliability of the metalized ceramic. Furthermore, the glass content in the ceramic metallization layer depends strongly on the dew point (DP) i.e., wetness of the reducing atmosphere during the firing process. The dew point sets the amount of moisture and therefore the partial pressure of oxygen in the atmosphere of the sintering furnace. The higher the dew point, the higher is the partial pressure of oxygen. A minimum partial pressure of oxygen is required during the sintering process in order to get enough wicking of the glass from the ceramic substrate to the ceramic metallization layer. The role of oxygen is to help with the wetting of the molybdenum particle in the metallization layer by the glass phase, thus enhancing the flow of the glass.

A failure mode termed “metallization stripping” may occur if the glass content in the ceramic metallization layer is too low and the bond to the ceramic substrate is weak if the dew point is not appropriately controlled. If the dew point is too low, the partial pressure of oxygen in the furnace is not high enough, which may lead to poor flow of the glass from the ceramic substrate to the porous ceramic metallization layer since as described above enough adsorbed oxygen on the molybdenum particles is required in order to provide good wetting by the glass and therefore good flow of the glass. As a result the bond between the ceramic metallization layer and the ceramic substrate may be poor. This may result in the failure mode called “metallization stripping” after the thermal compression bond is formed. The ceramic metallization layer may strip off as if the metallization was never done. This failure mode is rather undesirable because it is unpredictable and may happen at anytime during the cell operation.

Therefore, a need exists for a more robust system, where the design parameters can be controlled in a process with a large operation window. The metalized ceramic disclosed herein includes a ceramic metallization layer with a bond that is formed by grain growth of the ceramic in the ceramic metallization layer at the metallization interface with the ceramic substrate. The instant disclosure removes or minimizes the need for the presence of additional oxide species that are difficult to control and subsequently the need for a wet reducing atmosphere. The ceramic substrate comprising greater than about 6 weight percent impurities is by design impure, because the glass impurities in the ceramic substrate provide the bond between the ceramic substrate and the ceramic metallization layer. These impurities make the ceramic substrate susceptible to corrosion especially to the cathodic material or to the anodic material at high temperatures, which is undesirable for an electrochemcial cell. For example, if the electrochemical cell is a sodium metal halide cell, and the ceramic substrate is alumina, the alumina is susceptible to corrosion from sodium that is used as the anodic material. As discussed above, the ceramic metallization layer disclosed herein comprises a ceramic substrate having a purity of greater than about 95 percent. The structure further comprises a layer disposed on the ceramic substrate, wherein the layer comprises a second ceramic and a metal comprising nickel or a refractory metal. The second ceramic also has a purity of greater than about 95 percent.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components unless otherwise stated. Approximating language, as used herein throughout the specification and claims, may be applied to modify any quantitative representation that could permissibly vary without resulting in a change in the basic function to which it may be about related. Accordingly, a value modified by a term such as “about” is not limited to the precise value specified. In some instances, the approximating language may correspond to the precision of an instrument for measuring the value.

As used herein, cathodic material is the material that supplies electrons during charge and is present as part of a redox reaction. Anodic material accepts electrons during charge and is present as part of the redox reaction. As used herein, metallizing is the general name for the technique of coating metal on the surface of non-metallic objects. Because a non-metallic object tends to be a poor electrical conductor, the object's surface must be made conductive before any other metal can be bonded to the object's surface.

In accordance with an embodiment of the invention, a metalized ceramic is provided. The metalized ceramic comprises a ceramic substrate comprising a first ceramic and a ceramic metallization layer disposed on the ceramic substrate. The ceramic metallization layer comprises a mixture of (i) a second ceramic and (ii) a metal comprising nickel or a refractory metal. The refractory metal may consist one or more of molybdenum, tungsten, niobium and tantalum. The first ceramic and the second ceramic have a purity of greater than about 95 percent.

In one embodiment, the first ceramic comprises an electrically insulating ceramic. In one embodiment, the first ceramic comprises one or more of alpha-alumina, yttria, zirconia, yttria stabilized zirconia, yttrium aluminum garnet, magnesia alumina spinel, or yttrium aluminate perovskite. In one embodiment, the first ceramic comprises alpha-alumina.

In one embodiment, the second ceramic comprises an electrically insulating ceramic. In one embodiment, the second ceramic comprises one or more of alpha-alumina, yttria, zirconia, yttria stabilized zirconia, dysprosium oxide, yttrium aluminum garnet, magnesia alumina spinel, or yttrium aluminate perovskite. In one embodiment, the second ceramic comprises alpha-alumina.

The metal may be used to enable the diffusion bond with a metallic component or part to be joined to the ceramic substrate. In one embodiment, as mentioned above the metal may include nickel or a refractory metal. In one embodiment, the refractor metal consists one or more molybdenum tungsten, niobium, and tantalum. In one embodiment, the metal is molybdenum.

In various embodiments, there may be no specific limitation on the thickness of the ceramic substrate. In one embodiment, the ceramic substrate has a thickness in a range of about 0.25 millimeters to about 25 millimeters. In another embodiment, the ceramic substrate has a thickness in a range of about 1 millimeter to about 10 millimeters. In yet another embodiment, the ceramic substrate has a thickness in a range of about 2 millimeters to about 6 millimeters.

The ceramic metallization layer, typically comprising a metal selected from nickel, molybdenum, tungsten, niobium or tantalum may have a large coefficient of thermal expansion (CTE) mismatch with the ceramic substrate. In various embodiments, the ceramic metallization layer may have a thickness as small as possible from the stress point of view i.e., the CTE mismatch, yet thick enough to have sufficient second ceramic to provide a high enough bonding strength with a metal layer. In one embodiment, the ceramic metallization layer has a thickness in a range of about 5 micrometers to about 100 micrometers. In another embodiment, the ceramic metallization layer has a thickness in a range of about 10 micrometers to about 50 micrometers. In yet another embodiment, the ceramic metallization layer has a thickness in a range of about 15 micrometers to about 40 micrometers. In one embodiment, the ceramic metallization layer has a thickness of about 25 micrometers.

In one embodiment, the metal is present in the ceramic metallization layer in an amount in a range of about 5 to about 95 volume percent based on the amount of the second ceramic present in the ceramic metallization layer. In another embodiment, the metal is present in the ceramic metallization layer in an amount in a range of about 50 to about 90 volume percent based on the amount of the second ceramic present in the ceramic metallization layer. In yet another embodiment, the metal is present in the ceramic metallization layer in an amount in a range of about 60 to about 85 volume percent based on the amount of the second ceramic present in the ceramic metallization layer.

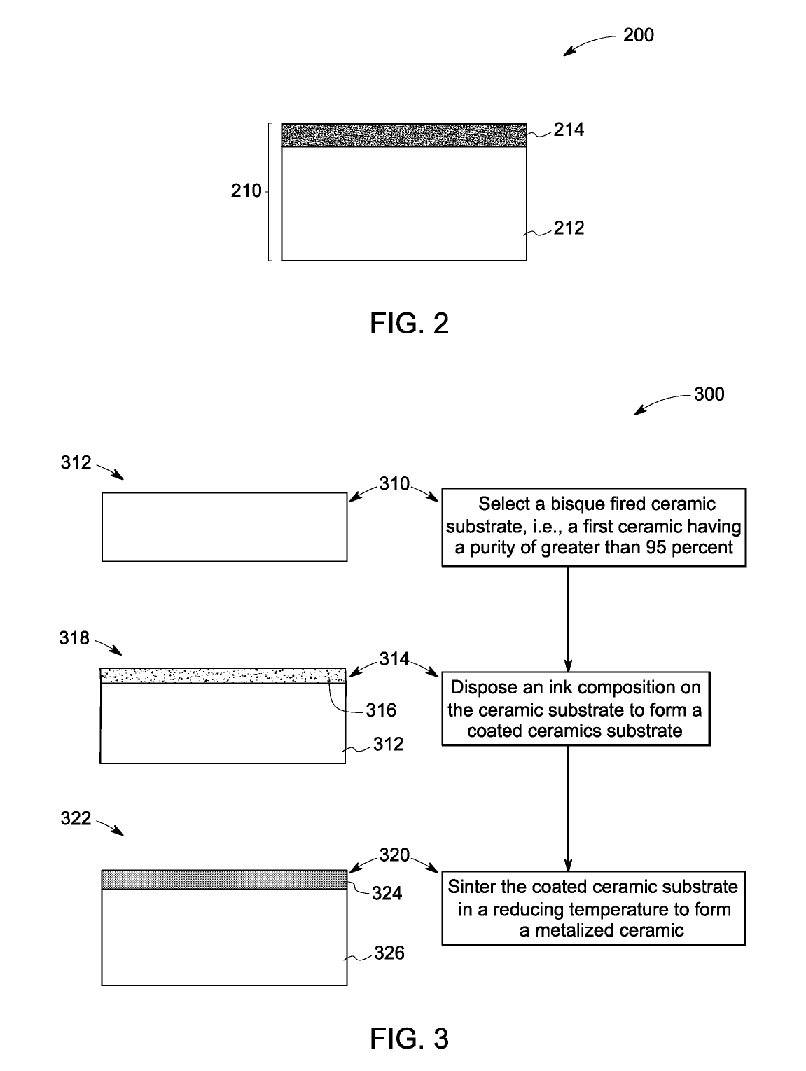

Referring to FIG. 2, a schematic view 200 showing a metalized ceramic 210 in accordance with one embodiment of the invention is provided. The metalized ceramic comprises a ceramic substrate 212 comprising a first ceramic, and a ceramic metallization layer 214 disposed over the ceramic substrate 212. The ceramic metallization layer 214 comprises a second ceramic (not shown in figure) and a metal comprising nickel or a refractory metal (not shown in figure).

In accordance with another embodiment of the invention a method, is provided. The method comprises disposing a layer of an ink composition on a ceramic substrate to form a coated ceramic substrate. The ceramic substrate comprises a first ceramic. The ink composition comprises a mixture of a second ceramic, a metal comprising nickel or a refractory metal and an organic vehicle material. The refractory metal consists of one or more of molybdenum, tungsten, niobium and tantalum. The first ceramic and the second ceramic have a purity of greater than about 95 percent. The method further comprises a step of sintering the coated ceramic substrate in a reducing atmosphere to form a physical bond between the layer of the ink composition and the ceramic substrate to form a ceramic metallization layer on the surface of the ceramic substrate.

Any suitable method known to one skilled in the art may be employed to dispose the layer of the ink-composition on the surface of the ceramic substrate. In one embodiment, the surface of the ceramic substrate on which the ink-composition is applied is the surface with which a metal layer may eventually be diffusion bonded to form a hermetic seal structure of an electrochemical cell. In one embodiment, the step of disposing comprises one or more of spraying, screen printing, brush-coating, spin-coating, and dip-coating.

In one embodiment, the average particle size of the second ceramic in the ink composition is in a range of about 0.5 micrometers to about 20 micrometers. In another embodiment, the average particle size of the second ceramic in the ink composition is in a range of about 1 micrometer to about 15 micrometers. In yet another embodiment, the average particle size of the second ceramic in the ink composition is in a range of about 5 micrometers to about 10 micrometers.

In one embodiment, the average particle size of the metal in the ink composition is in a range of about 0.5 micrometers to about 20 micrometers. In another embodiment, the average particle size of the metal in the ink composition is in a range of about 0.8 micrometer to about 15 micrometers. In yet another embodiment, the average particle size of the metal in the ink composition is in a range of about 1 micrometer to about 5 micrometers.

In one embodiment, the ink composition comprises an organic vehicle material and a dispersant. As discussed herein below, the ceramic metallization layer is formed, by disposing an ink composition on the surface of the first ceramic. The ink composition comprises a second ceramic, a metal comprising nickel or a refractory metal, and an organic vehicle material. In one embodiment, the ink composition may include a dispersant. After sintering and formation of the metalized substrate comprising the ceramic substrate and the ceramic metallization layer, the ceramic metallization layer contains only the metal and the second ceramic with no or negligible amount of the organic vehicle material or dispersant. In one embodiment, any suitable organic vehicle material and dispersant that may allow for the convenient application of the metal on the surface of the ceramic substrate may be employed. Similarly, in one embodiment, the amount of suitable organic vehicle material and dispersant may be such that the amount allows for the convenient application of the metal on the surface of the ceramic substrate. In one embodiment, the organic vehicle material includes a 5 weight percent solution of ethyl cellulose in α-terpineol, wherein the α-terpineol is at least 95 percent pure. In one embodiment, the dispersant consists of Darvan C. In one embodiment, the amount of dispersant employed may be about 5 weight percent based on the total amount of the organic vehicle material.

In one embodiment, the metal is present in the ceramic metallization layer in an amount in a range of about 5 to about 95 volume percent based on the amount of the second ceramic present in the layer. In another embodiment, the metal is present in the layer in an amount in a range of about 50 volume percent to about 90 volume percent based on the amount of the second ceramic present in the layer. In yet another embodiment, the metal is present in the layer in an amount in a range of about 60 volume percent to about 85 volume percent based on the amount of the second ceramic present in the layer.

In one embodiment, the organic vehicle material is present in the ink composition in an amount in a range of about 10 weight percent to about 40 weight percent based on the total amount of the second ceramic and the metal present in the ink composition. In another embodiment, the organic vehicle material is present in the ink composition in an amount in a range of about 15 weight percent to about 35 weight percent based on the total amount of the second ceramic and the metal present in the ink composition. In yet another embodiment, the organic vehicle material is present in the ink composition in an amount in a range of about 20 weight percent to about 30 weight percent based on the total amount of the second ceramic and the metal present in the ink composition.

In one embodiment, the dispersant is present in the ink composition in an amount in a range of about 0.5 weight percent to about 30 weight percent based on the amount of the second organic vehicle material in the ink composition. In another embodiment, the dispersant is present in the ink composition in an amount in a range of about 0.8 weight percent to about 20 weight percent based on the amount of the organic vehicle material present in the ink composition. In yet another embodiment, the dispersant is present in the ink composition in an amount in a range of about 1 weight percent to about 10 weight percent based on the amount of the organic vehicle material present in the ink composition.

In one embodiment, a reducing or an inert atmosphere is required to prevent excessive oxidation of the metal. In one embodiment, the reducing or inert atmosphere may comprise hydrogen gas, nitrogen, argon, mixture of hydrogen and nitrogen, or vacuum. The reducing atmosphere is employed as there is a negative effect of high partial pressure of oxygen (high dew point as discussed above) and that is when the pressure of oxygen is high, oxides and hydroxides of Mo form in the gas phase, which may lead to significant loss of Mo from the metallization layer. In order to prevent the oxidation a reducing atmosphere is used.

In one embodiment, the ceramic substrate may be bisque fired before the application of the ink composition layer. The bisque firing step may typically be carried out to bring the ceramic substrate to a density of about 50 percent. In one embodiment, the bisque firing is carried out at a temperature in a range of about 1000 degrees Centigrade to about 1400 degrees Centigrade for a period of about 30 minutes to about 5 hours. In one embodiment, the sintering is carried out at a temperature of about 1200 degrees centigrade for about 3 hours. The bisque firing of the ceramic substrate causes permanent chemical and physical changes to occur in the ceramic substrate. Bisque firing result in a much harder and more resilient ceramic substrate which is still porous and able to absorb the ink composition.

In one embodiment, the step of sintering the ink coated substrate in a reducing atmosphere to form the ceramic metallization layer is carried out at a temperature in a range of from about 1400 degrees Centigrade to about 1800 degrees Centigrade. In another embodiment, the temperature is in a range of from about 1400 degrees Centigrade to about 1700 degrees Centigrade. In yet another embodiment, the temperature is in a range of from about 1500 degrees Centigrade to about 1650 degrees Centigrade. In one embodiment, the sintering of the coated substrate is carried out for a period in a range of about 30 minutes to about 10 hours. In another embodiment, the sintering of the coated substrate is carried out for a period in a range of about 1 hour to about 5 hours. In yet another embodiment, the sintering of the coated substrate is carried out for a period in a range of about 2 hours to about 3 hours.

Referring to FIG. 3, a schematic view 300 showing a step-wise method of forming a ceramic metallization layer in accordance with one embodiment of the invention. In a first step 310 a ceramic substrate 312 comprising a bisque fired first ceramic having a purity of greater than 95 percent is selected. In one embodiment, the ceramic substrate 312 is at least 99 percent alumina. In a second step 314 an ink composition 316 is deposited over the ceramic substrate 312 to form a coated ceramic substrate 318. In one embodiment, the ink composition 316 comprises a mixture of a second ceramic, for example, alumina having a purity of 99 percent and molybdenum. In a third step 320 the coated ceramic substrate 318 is sintered in a reducing temperature to form a metalized ceramic 322 comprising a ceramic metallization layer 324 and the modified ceramic substrate 312.

In accordance with yet another embodiment of the invention a method is provided. The method comprises bisque firing a ceramic substrate followed by disposing a layer of an ink composition on the ceramic substrate to form a coated ceramic substrate. The ceramic substrate comprises a first ceramic. The ink composition comprises a mixture of a second ceramic, a metal, and an organic vehicle material. The metal comprises nickel or a refractory metal consisting of one or more of molybdenum, tungsten niobium, and tantalum. The first ceramic and the second ceramic have a purity of greater than about 95 percent. The method further comprises sintering the coated ceramic substrate in a reducing atmosphere to form a physical bond between the layer and the ceramic substrate to form a ceramic metallization layer. The method further comprises disposing a metal layer on the ceramic metallization layer; and sintering the metal-coated ceramic metallization layer to form a diffusion bond between the metal layer and the metalized ceramic. In one embodiment, the step of sintering the metal coated ceramic metallization layer to form a metal coated metalized ceramic is carried out at a temperature as discussed above. In one embodiment, the metal layer comprises nickel or molybdenum.

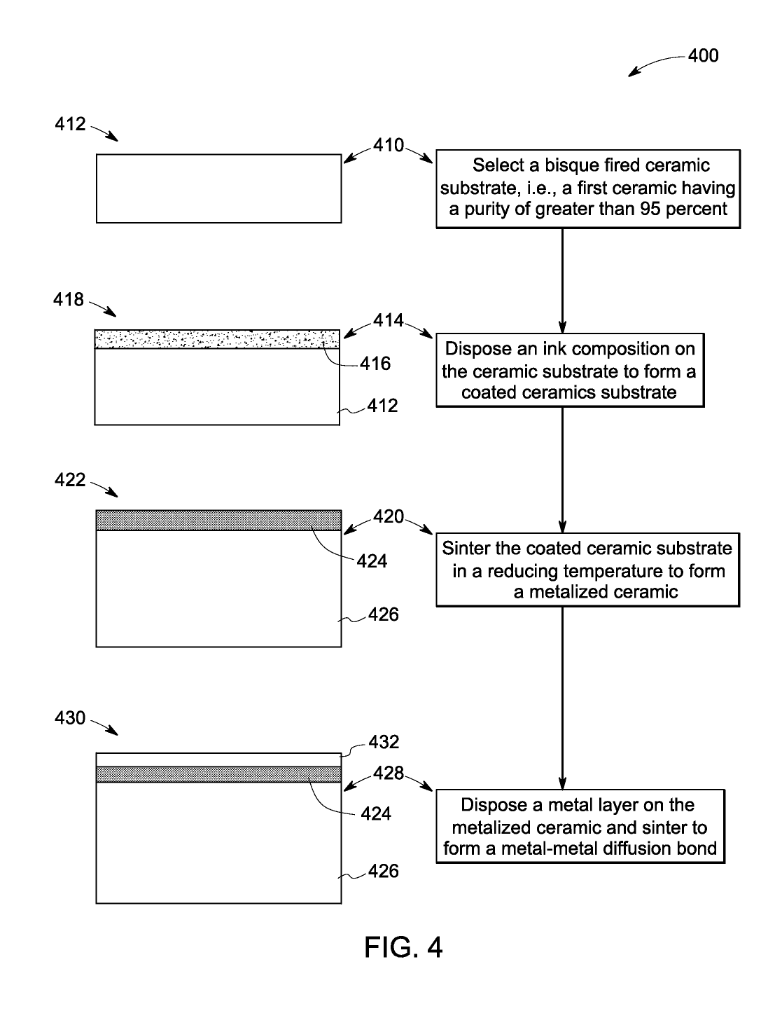

Referring to FIG. 4, a schematic view 400 showing a step-wise method of forming a diffusion bond between a metalized ceramic and a metal layer in accordance with one embodiment of the invention. In a first step 410 a ceramic substrate 412 comprising a bisque fired first ceramic having a purity of greater than 95 percent is selected. In one embodiment, the ceramic substrate 412 is 99 percent alumina. In a second step 414 an ink composition 416 is deposited over the ceramic substrate 412 to form a coated ceramic substrate 418. In a third step 420 the coated ceramic substrate 418 is sintered in a reducing temperature to form a metalized ceramic 422 comprising a ceramic metallization layer 424 and the ceramic substrate 412. In a fourth step 426 a metal layer 428 is disposed on the ceramic metallization layer 424 of the metalized ceramic 422 and then sintered to form a metal-metal thermal compression bond, i.e., a diffusion bond 430 between the metalized ceramic 422 and the metal layer 428.

In accordance with yet another embodiment of the invention an electrochemical cell is provided. The cell comprises an anode current collector attached to a anode terminal, a cathode current collector attached to a cathode terminal, a ion-conducting first electrolyte, and an electrically insulating collar disposed on the ion-conducting first electrolyte. The electrically insulating collar comprises a ceramic substrate comprising a first ceramic. A ceramic metallization layer is disposed on the ceramic substrate. The ceramic metallization layer comprises a mixture of (i) a second ceramic and (ii) a metal comprising nickel or a refractory metal. The refractory metal consists of one or more of molybdenum, tungsten, niobium, and tantalum. The first ceramic and the second ceramic have a purity of greater than about 95 percent.

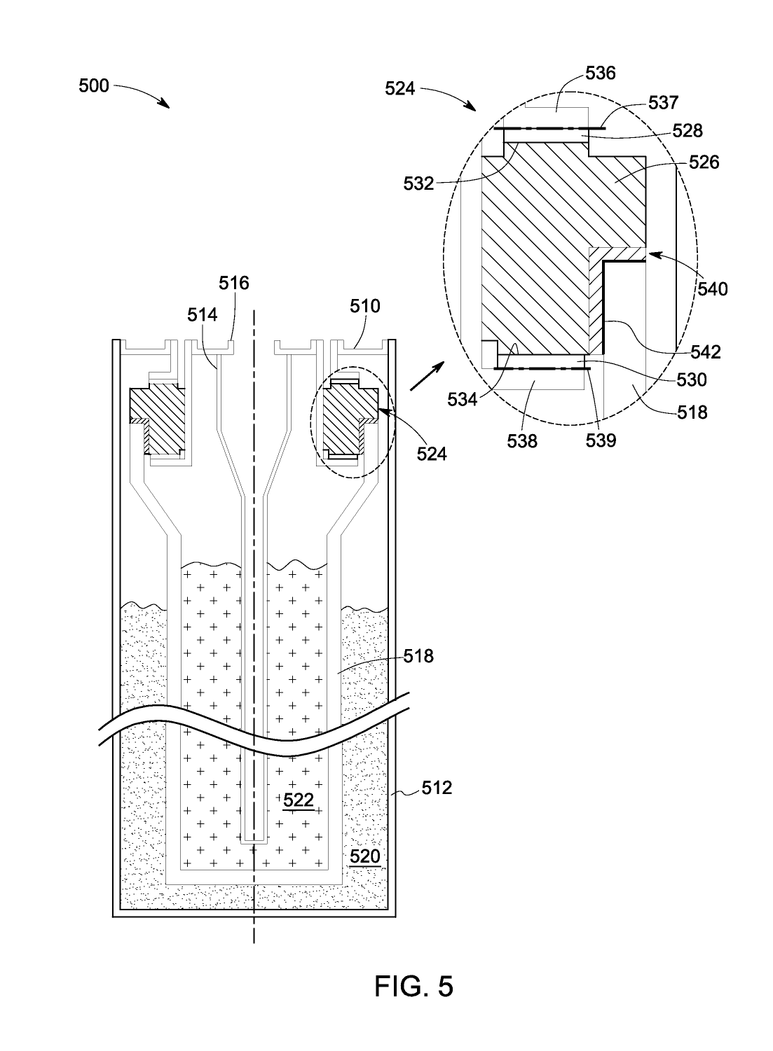

Referring to FIG. 5, a schematic view showing a cross section of an electrochemical cell 500 in accordance with the present invention is provided. FIG. 5 includes an anode current collector 510, attached to an anode terminal 512, a cathode current collector attached 514 attached to a cathode terminal 516, and a beta-alumina tube 518 functioning as the ion-conducting first electrolyte. The electrochemical cell includes an outer metal container that functions as a negative anode terminal 512 for sodium 520 as anodic material. A metal rod functions as the cathode current collector 514, the metal rod being surrounded by a cathodic material 522, a positive electrode material infused with molten halide. A metalized ceramic 524 is formed as discussed above where the ceramic substrate 526 of the metalized ceramic 524 comprises a ceramic with a purity of greater than about 95 percent. Ceramic metallization layers 528, 530 are formed on at least two surfaces 532, 534 of the ceramic substrate 526 to form the metalized ceramic 524 via the formation of a physical bond 537, 539 between the ceramic metallization layers 528, 530 and the ceramic substrate 526. The metal layers 536, 538, for example, nickel layers, are then disposed over the ceramic metallization layers 528, 530. The metal layer 536 is used to connect the metalized ceramic 524 to the negative anode terminal 512, and the metal layer 538 is used to connect the metalized ceramic 524 to the cathode current terminal 514. The metalized ceramic 524 and the metal layers 536, 538 assembly so formed may then be disposed over the beta-alumina tube 518. A sealing glass 540 is employed to bond the metalized ceramic 524 to the beta-alumina tube 518. The portion of the metalized ceramic 524 bonded to the beta-alumina tube 518 may not comprise a ceramic metallization layer, and the bond formed is a ceramic-ceramic bond 542, formed using the sealing glass 540.

The ceramic metallization layer discussed herein may have various applications including electronic applications where ceramics are used as insulators in circuit boards and need to be bonded to metals, in lighting application (ceramic metal halide lamps), where metallic feedthrough need to be bonded to ceramic discharge chamber of the lamp, and in electrochemical cells.

### EXAMPLES

The following examples illustrate methods and embodiments in accordance with the invention, and as such should not be construed as imposing limitations upon the claims. Unless specified otherwise, all components are commercially available from common chemical suppliers such as Sigma-Aldrich (United States), and the like.

### Example

### Formation of Ceramic Metallization Layer

### Preparation of Ink-Composition

Refractory metal (molybdenum powder, obtained from Alfa Aesar, average particle size of about 3 micrometers in diameter, 99.9 percent pure, 75 volume percent based on the total volume of the ink composition), second ceramic (alpha-alumina powder, CR10, average particle size 1 micrometer to about 5 micrometer in diameter, 99.9 percent pure, 55 volume percent based on the total volume of the ink composition), organic vehicle material (a mixture of alpha-terpineol and ethyl cellulose containing 5 weight percent ethyl cellulose, about 10 weight percent based on the total weight of the ink paste), and Darvan C dispersant (5 weight percent of organic vehicle material added, obtained from R.T. Vanderbilt Company, Inc., Norwalk, Conn.). The process for forming the ink composition included the following steps. The molybdenum powder and the alpha-alumina powder were added to a plastic container and the powders were thoroughly mixed. About 1 g of organic vehicle material was added to the resultant mixture. Darvan C was added and the mixture mixed thoroughly. Place the resultant mixture into a Thinky planetary vacuum mixer, model ARV-310. The materials were mixed at 5000 rotations per minute for about 30 seconds. The thorough mixing step and the vacuum mixer step are repeated two more times.

### Preparation of First Ceramic:

Bisque fire the first ceramic alpha alumina, 99.9 percent pure, thickness 4 millimeters and average particle size 5 micrometers.). The bisque fired alumina part is cleaned with isopropanol. The solvent is pat dried with Kim wipes and the alumina is air dried for at least 5 minutes.

### Screen Printing Ink Composition on the First Ceramic

Weltek International Inc. (South Bend, ID), model 54D screen printer was employed to screen print the ink composition over the first ceramic. A mesh size of 105 was used for screen printing the ink. The coated alumina parts are then dried by placing screen printed parts in a drying oven set to about 50 degrees Centigrade and dried for about 16 hours.

### Sintering of Coated First Ceramic

The coated ceramic is sintered at a temperature of about 1650 degrees Centigrade for about 5 hours in an atmosphere of hydrogen. The thickness of the metallization layer as printed is about 50 micrometers to about 40 micrometers.

Finally, a metal layer (or metal component) made of Nickel is disposed on the surface of the metalized ceramic, then this system is subjected to a thermal compression bond (TCB) process. During the TCB process, a uni-axial pressure load is applied on the metal layer-metalized ceramic system, under a temperature of about 950 centigrade, resulting in a diffusion bond between the metal layer and the metallization layer of the metalized ceramic.

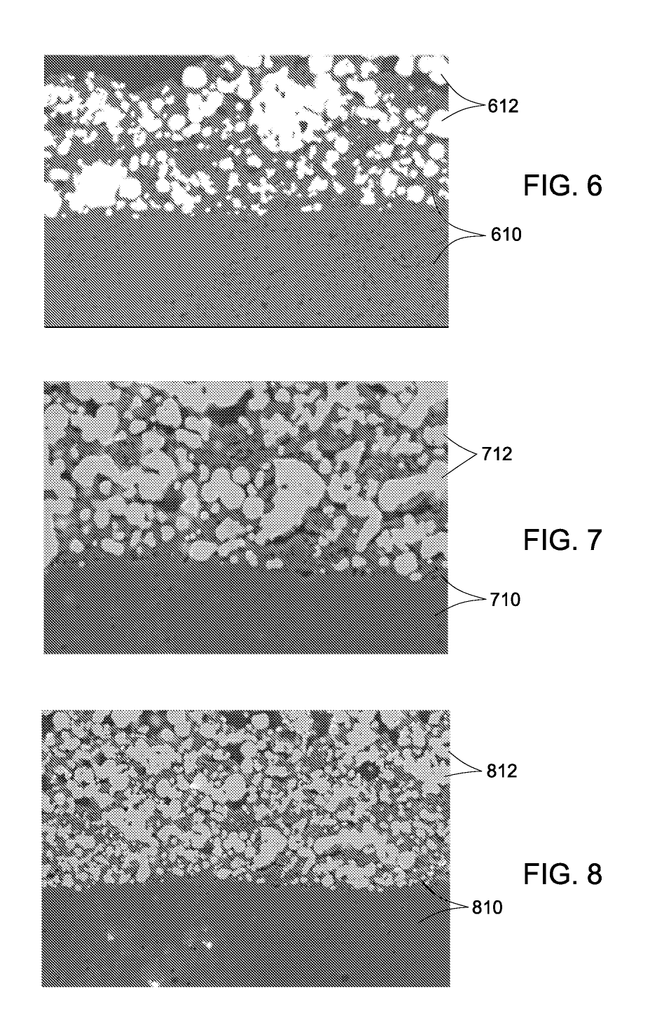

Referring to FIGS. 6, 7, and 8, a pictorial view of the scanning electron microscopy (SEM; 10 micrometer scale) of the ceramic metallization layer is shown. The SEM shown in FIG. 6 shows the ceramic metallization layer formed over a ceramic substrate, where the ceramic metallization layer consists of 50 volume percent of alumina, and the sintering in reduced atmosphere was carried out at a temperature of about 1500 degrees Centigrade. The SEM shown in FIG. 7 shows the ceramic metallization layer formed over a ceramic substrate, where the ceramic metallization layer consists of 40 volume percent of alumina, and the sintering in reduced atmosphere was carried out at a temperature of about 1600 degrees Centigrade. The SEM shown in FIG. 8 shows the ceramic metallization layer formed over a ceramic substrate, where the ceramic metallization layer consists of 30 volume percent of alumina, and the sintering in reduced atmosphere was carried out at a temperature of about 1600 degrees Centigrade. The dark phases indicated by 610, 710, and 810 indicate alumina and the white phases 612, 712, and 812 indicate molybdenum. The SEM shows the formation of the ceramic metallization layer.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A metalized ceramic, comprising:
a ceramic substrate comprising a first ceramic;
a ceramic metallization layer disposed on the ceramic substrate, wherein the ceramic metallization layer comprises a mixture of:
i. a second ceramic and
ii. a metal comprising nickel or a refractory metal consisting one or more of molybdenum, tungsten, niobium and tantalum;
wherein the first ceramic and the second ceramic have a purity of greater than about 95 percent.

2. The metalized ceramic of claim 1, wherein the first ceramic comprises an electrically insulating ceramic.

3. The metalized ceramic of claim 1, wherein the first ceramic comprises alpha-alumina, yttria, yttria stabilized zirconia, zirconia, yttrium aluminum garnet, magnesia alumina spinel, yttrium aluminate perovskite, or combinations thereof.

4. The metalized ceramic of claim 1, wherein the second ceramic comprises an electrically insulating ceramic.

5. The metalized ceramic of claim 1, wherein the second ceramic comprises alpha-alumina, yttria, yttria stabilized zirconia, zirconia, yttrium aluminum garnet, magnesia alumina spinel, dysprosium oxide, or yttrium aluminate perovskite.

6. The metalized ceramic of claim 1, wherein the second ceramic comprises alpha-alumina.

7. The metalized ceramic of claim 1, wherein the metal is molybdenum.

8. The metalized ceramic of claim 1, wherein the ceramic substrate has a thickness in a range of about 0.55 millimeters to about 55 millimeters.

9. The metalized ceramic of claim 1, wherein the ceramic metallization layer has a thickness in a range of about 5 micrometers to about 100 micrometers.

10. The metalized ceramic of claim 1, wherein the refractory metal is present in the layer in an amount in a range of about 10 volume percent to about 40 volume percent based on the amount of the second ceramic present in the layer.

11. A method, comprising:
disposing a layer of an ink composition on a ceramic substrate to form a coated ceramic substrate; wherein the ceramic substrate comprises a first ceramic and wherein the ink composition comprises a mixture of a second ceramic, a metal comprising nickel or a refractory metal consisting one or more of molybdenum, tungsten, niobium and tantalum, and an organic vehicle material; wherein the first ceramic and the second ceramic have a purity of greater than about 95 percent;
sintering the coated substrate in a reducing atmosphere to form a physical bond between the layer and the ceramic substrate to form a ceramic metallization layer.

12. The method of claim 11, wherein the disposing comprises one or more of spraying, screen printing, brush-coating, spin-coating, and dip-coating.

13. The method of claim 11, wherein the ceramic metallization layer has a thickness in a range of about 5 micrometers to about 100 micrometers.

14. The method of claim 11, wherein the wherein the metal is present in the layer in an amount in a range of about 50 volume percent to about 90 volume percent based on the amount of the second ceramic present in the layer.

15. The method of claim 11, wherein the wherein the organic vehicle material is present in the ink composition in an amount in a range of about 10 weight percent to about 40 weight percent based on the total amount of the second ceramic and the metal present in the layer.

16. A method, comprising:
disposing a layer of an ink composition on a ceramic substrate to form a coated ceramic substrate; wherein the ceramic substrate comprises a first ceramic and wherein the ink composition comprises a mixture of a second ceramic, a metal comprising nickel or a refractory metal consisting one or more of molybdenum, tungsten, niobium and tantalum, and an organic vehicle material; wherein the first ceramic and the second ceramic have a purity of greater than about 95 percent;
sintering the coated substrate in a reducing atmosphere to form a physical bond between the layer and the ceramic substrate to form a ceramic metallization layer;
disposing a metal layer on the ceramic metallization layer; and
sintering to form a diffusion bond between the metal layer and the metalized ceramic.

17. The method of claim 16, wherein the metal layer comprises nickel or molybdenum.

18. An electrochemical cell, comprising:
an anode current collector attached to an anode terminal;
a cathode current collector attached to a cathode terminal;
an ion-conducting first electrolyte; and
an electrically insulating collar disposed on the ion-conducting first electrolyte; the electrically insulating collar comprising
a ceramic substrate comprising a first ceramic;
a ceramic metallization layer disposed on the ceramic substrate, wherein the ceramic metallization layer comprises a mixture of:
i. a second ceramic and
ii. a metal comprising nickel or a refractory metal consisting one or more of molybdenum, tungsten, niobium, and tantalum;
wherein the first ceramic and the second ceramic have a purity of greater than about 95 percent.

19. The electrochemical cell of claim 18, wherein the first ceramic comprises an electrically insulating ceramic.

20. The electrochemical cell of claim 18, wherein the first ceramic comprises alpha-alumina, yttria, zirconia, yttria stabilized zirconia, yttrium aluminum garnet, magnesia alumina spinel, and yttrium aluminate perovskite.

21. The electrochemical cell of claim 18, wherein the second ceramic comprises alpha-alumina, yttria, zirconia, yttria stabilized zirconia, yttrium aluminum garnet, magnesia alumina spinel, dysprosium oxide, and yttrium aluminate perovskite.

22. The electrochemical cell of claim 18, wherein the second ceramic comprises alpha-alumina.

23. The electrochemical cell of claim 18, wherein the refractory metal is molybdenum.
